(19) United States
(12) Patent Application Publication
(10) Pub. No.: US 2025/0199771 A1
(43) Pub. Date: Jun. 19, 2025

(54) DEVICES AND METHODS FOR SECURE MULTI-PARTY COMPUTATION WITH CORRELATED RANDOMNESS

(71) Applicant: Robert Bosch GmbH, Stuttgart (DE)

(72) Inventors: Christoph Boesch, Kirchentellinsfurt (DE); Enrico Sorbera, Stuttgart (DE); Sven Trieflinger, Renningen (DE); Vincent Sebastian Rieder, Stuttgart (DE)

(21) Appl. No.: 18/970,383

(22) Filed: Dec. 5, 2024

(30) Foreign Application Priority Data
Dec. 14, 2023 (DE) 10 2023 212 693.1

(51) Int. Cl. G06F 7/58

(52) U.S. Cl. CPC G06F 7/582

(57) ABSTRACT

Secure multi-party computation. A first device is configured for receiving first correlated randomness, and determining second correlated randomness depending on the first correlated randomness, and includes a coordinator that is configured for scheduling the determining of the second correlated randomness, and/or for requesting a predetermined amount of the first correlated randomness at a predetermined time, from a coordinator for multiple devices for secure multi-party computation, and/or for sending a predetermined amount of the second correlated randomness at a predetermined time. A second device and a second method for secure multi-party computation, wherein the second device is configured for receiving a request for a predetermined amount of first correlated randomness at a predetermined time, and sending the predetermined amount of first correlated randomness at the predetermined time.

### CROSS REFERENCE

The present application claims the benefit under 35 U.S.C. § 119 of German Patent Application No. DE 10 2023 212 693.1 filed on Dec. 14, 2023, which is expressly incorporated herein by reference in its entirety.

### FIELD

The present invention relates to devices and methods for secure multi-party computation with correlated randomness.

### BACKGROUND INFORMATION

“Efficient Pseudorandom Correlation Generators from Ring-LPN”, Boyle, E., Couteau, G., Gilboa, N., Ishai, Y., Kohl, L., Scholl, P. (2020); “Efficient Pseudorandom Correlation Generators from Ring-LPN;” in: Micciancio, D., Ristenpart, T. (eds) Advances in Cryptology-CRYPTO 2020. CRYPTO 2020. Lecture Notes in Computer Science( ), vol 12171. Springer, Cham. doi.org/10.1007/978-3-030-56880-1_14, (Boyle 2020) describes secure multiparty computation that utilizes correlated randomness to achieve better efficiency.

### SUMMARY

Devices and methods according to the present invention provide explicit coordination in secure multi-party computation with correlated randomness.

According to an example embodiment of the present invention, a first device for secure multi-party computation is configured for receiving first correlated randomness, and determining second correlated randomness depending on the first correlated randomness, and a coordinator that is configured for scheduling the determining of the second correlated randomness, and/or for requesting, in particular a predetermined amount, of the first correlated randomness, in particular at a predetermined time, from a coordinator for multiple devices for secure multi-party computation, and/or for sending, in particular a predetermined amount, of the second correlated randomness, in particular at a predetermined time. The first device is a component of the multi-party computation that generates the second correlated randomness.

The coordinator may be configured for receiving a request for sending, in particular the predetermined amount, of the second correlated randomness, in particular at the predetermined time, from a coordinator for multiple devices for secure multi-party computation, and for sending, in particular the predetermined amount, of the second correlated randomness upon receipt of the request, in particular at the predetermined time. This means, the first device is capable of providing correlated randomness upon request.

The first device may comprise a buffer for the first correlated randomness, wherein the coordinator is configured for reading an amount of the first correlated randomness that is stored in the buffer for the first correlated randomness, and for requesting, in particular the predetermined amount, of the first correlated randomness, when the amount of the correlated randomness is less than a predetermined threshold. This means, the first device is capable of coordinating the filling of the buffer for the first correlated randomness.

The first device may comprise a buffer for the second correlated randomness, wherein the coordinator is configured for reading an amount of the second correlated randomness that is stored in the buffer for the second correlated randomness, and for sending, in particular the predetermined amount, of the second correlated randomness. This means, the first device is capable of coordinating the sending of the second correlated randomness from the buffer for the second correlated randomness.

The first device may be configured for generating a pseudo random correlation generator seed depending on the first correlated randomness, and determining the second correlated randomness depending on the pseudo random correlation generator seed, and wherein the coordinator is configured for scheduling the generation of the pseudo random correlation generator seed from the first correlated randomness. This means, the first device is capable of coordinating the generation of seed.

The first device may comprise a buffer for pseudo random correlation generator seeds, wherein the coordinator is configured for reading an amount of pseudo random correlation generator seeds that is stored in the buffer for the pseudo random correlation generator seeds, and for requesting the generation of the pseudo random correlation generator seed from the first correlated randomness, when the amount of pseudo random correlation generator seeds is less than a predetermined threshold. This means, the first device comprises a pseudorandom correlation generator and is capable of coordinating the pseudorandom correlation generator.

The pseudorandom correlation generator may be part of a pseudorandom correlation generator module that comprises input and output wires.

The first device, for example, comprises an input wire that is configured for reading in the first correlated randomness.

The first device for example comprises an output wire that is configured for sending the second correlated randomness.

According to an example embodiment of the present invention, in a decentralized coordination, a set of first devices may be used, that comprise coordinators, that are adapted for coordination between the first devices.

According to an example embodiment of the present invention, a second device for secure multi-party computation is configured for receiving a request for, in particular a predetermined amount of, first correlated randomness, in particular at a predetermined time, and sending, in particular the predetermined amount, of first correlated randomness, in particular at the predetermined time. The second device is a component of the multi-party computation that coordinates the multi-party computation. The second device is configured for a coordination of the multi-party computation, in particular of the first device or of the set of first devices.

A first method for secure multi-party computation in a first device for secure multi-party computation comprises receiving first correlated randomness, and determining second correlated randomness depending on the first correlated randomness, and, in particular with a coordinator in the first device, scheduling the determining of the second correlated randomness, and/or requesting, in particular a predetermined amount, of the first correlated randomness, in particular at a predetermined time, from a coordinator for multiple devices for secure multi-party computation, or the buffer for the second correlated randomness, and/or sending, in particular a predetermined amount, of the second correlated randomness, in particular at a predetermined time, to the buffer for the second correlated randomness. The explicit coordination improves the performance of the multi-party computation with correlated randomness.

According to an example embodiment of the present invention, the method may comprise, receiving, in particular with the coordinator of the first device, a request for sending, in particular the predetermined amount, of the second correlated randomness, in particular at the predetermined time, from a coordinator for multiple devices for secure multi-party computation, or the buffer for the second correlated randomness, and for sending, in particular the predetermined amount, of the second correlated randomness upon receipt of the request, in particular at the predetermined time. The second correlated randomness that is generated is sent upon the request to answer a request. This improves the coordination further.

The first device may comprise a buffer for the first correlated randomness, wherein the first method comprises reading, in particular with the coordinator of the first device, an amount of the first correlated randomness that is stored in the buffer for the first correlated randomness, and for requesting, in particular the predetermined amount, of the first correlated randomness, when the amount of the correlated randomness is less than a predetermined threshold, and/or in that the first device comprises a buffer for the second correlated randomness, wherein the first method comprises reading, in particular with the coordinator of the first device, an amount of the second correlated randomness that is stored in the buffer for the second correlated randomness, and for sending, in particular the predetermined amount, of the second correlated randomness. According to this coordination, the first method requests the first correlated randomness that is needed or sends the second correlated randomness that is needed.

The first method may comprise generating a pseudo random correlation generator seed depending on the first correlated randomness, and determining the second correlated randomness depending on the pseudo random correlation generator seed, and scheduling, in particular with the coordinator of the first device, the generation of the pseudo random correlation generator seed from the first correlated randomness.

The first device may comprise a buffer for pseudo random correlation generator seeds, wherein the first method comprises reading, in particular with the coordinator of the first device, an amount of pseudo random correlation generator seeds that is stored in the buffer for the pseudo random correlation generator seeds, and requesting, in particular with the coordinator of the first device, the generation of the pseudo random correlation generator seed from the first correlated randomness, when the amount of pseudo random correlation generator seeds is less than a predetermined threshold. The first method operates the buffer in a coordinated way in the pseudo random correlation generator.

According to an example embodiment of the present invention, a second method for secure multi-party computation comprises receiving a request for, in particular a predetermined amount of, first correlated randomness, in particular at a predetermined time, and sending, in particular the predetermined amount, of first correlated randomness, in particular at the predetermined time. The second method coordinates the correlated randomness in the plurality of devices for secure multi-party computation.

A computer program may comprise computer-readable instructions that, when executed by a computer, cause the computer to execute the first method of the present invention or the second method of the present invention.

Further embodiments of the present invention are derivable from the following description and the figures.

### BRIEF DESCRIPTION OF THE DRAWINGS

FIG. 1 schematically depicts an exemplary module for secure multi-party computation with correlated randomness based on a pseudo random correlation generator, according to the present invention.

FIG. 2 schematically depicts an exemplary module for secure multi-party computation with correlated randomness based on a correlation generator, according to the present invention.

FIG. 3 schematically depicts an exemplary coordinator for a plurality of modules for secure multi-party computation, according to the present invention.

FIG. 4 depicts a sequence diagram of an exemplary method for coordinating the plurality of modules for secure multi-party computation with the coordinator, according to the present invention.

### DETAILED DESCRIPTION OF EXAMPLE EMBODIMENTS

FIG. 1 schematically depicts an exemplary module for secure multi-party computation with correlated randomness based on a pseudo random correlation generator.

The module according to the example comprises a first device 100 for secure multi-party computation.

The first device 100 is configured for receiving first correlated randomness.

First correlated randomness in this context refers to different types of correlated randomness that is generated by different participants of the secure multi-party computation. An example for a type of first correlated randomness is Beaver triples.

The first device 100 is configured for receiving first correlated randomness determining second correlated randomness depending on the first correlated randomness.

More specifically, the first device 100 is configured for generating a pseudo random correlation generator seed depending on the first correlated randomness.

More specifically, the first device 100 is configured for determining the second correlated randomness depending on the pseudo random correlation generator seed.

The first device 100 comprises a buffer 102 for the first correlated randomness.

The first device 100 comprises a buffer 104 for pseudo random correlation generator seeds.

The first device 100 comprises a buffer 106 for the second correlated randomness.

The first device 100 comprises an input wire 108 that is configured for reading in the first correlated randomness.

The first device 100 comprises an output wire 110 that is configured for sending the second correlated randomness.

The first device 100 comprises a coordinator 112.

According to an example, the coordinator 112 is configured for scheduling the determining of the second correlated randomness.

According to an example, the coordinator 112 is configured for scheduling the generation of the pseudo random correlation generator seed from the first correlated randomness.

According to an example, the coordinator 112 is configured for scheduling the determining of the second correlated randomness from the pseudo random correlation generator seed.

According to an example, the coordinator 112 is configured for requesting of the first correlated randomness.

According to an example, the coordinator 112 is configured for reading an amount of the first correlated randomness that is stored in the buffer 102 for the first correlated randomness.

According to an example, the coordinator 112 is configured for requesting, in particular the predetermined amount, of the first correlated randomness, when the amount of the first correlated randomness is less than a predetermined threshold.

The coordinator 112 may be configured for requesting a predetermined amount of the first correlated randomness.

The coordinator 112 may be configured for requesting, in particular the predetermined amount, of the first correlated randomness, at a predetermined time.

The coordinator 112 may be configured for requesting, in particular the predetermined amount, of the first correlated randomness from a coordinator for multiple devices for secure multi-party computation.

The coordinator 112 may be configured for requesting, in particular the predetermined amount, of the first correlated randomness from the buffer 106 for the second correlated randomness.

According to an example, the coordinator 112 is configured for requesting the generation of the pseudo random correlation generator seed from the first correlated randomness, when the amount of pseudo random correlation generator seeds is less than a predetermined threshold.

According to an example, the coordinator 112 is configured for sending the second correlated randomness.

According to an example, the coordinator 112 is configured for reading an amount of the second correlated randomness that is stored in the buffer 106 for the second correlated randomness.

According to an example, the coordinator 112 is configured for sending, in particular the predetermined amount, of the second correlated randomness.

The coordinator 112 may be configured for sending a predetermined amount of the second correlated randomness.

The coordinator 112 may be configured for sending, in particular the predetermined amount, of the second correlated randomness, at a predetermined time.

The coordinator 112 may be configured for sending, in particular the predetermined amount, of the second correlated randomness to the buffer 106 for the second correlated randomness.

The coordinator 112 may be configured for receiving a request for sending the second correlated randomness from a coordinator for multiple devices for secure multi-party computation.

The coordinator 112 may be configured to receive the request for sending the second correlated randomness from the buffer 106 for the second correlated randomness.

The coordinator 112 may be configured for receiving a request for sending the predetermined amount of the second correlated randomness.

The coordinator 112 may be configured for receiving the request for sending, in particular the predetermined amount, of the second correlated randomness at the predetermined time.

According to an example, the coordinator 112 is configured for sending, in particular the predetermined amount, of the second correlated randomness upon receipt of the request.

According to an example, the coordinator 112 is configured for sending, in particular the predetermined amount, of the second correlated randomness upon receipt of the request at the predetermined time.

According to an example, the coordinator 112 is configured for sending, in particular the predetermined amount, of the second correlated randomness to the requesting coordinator for multiple devices for secure multi-party computation or to the requesting other device for secure multi-party computation.

According to an example, the first device 100 comprises at least one processor 114 and at least one memory 116. The at least one memory 116 in the example comprises the first buffer 102, and the third buffer 106. The at least one memory 116 comprises the second buffer 104 for in case the first device 100 comprises the pseudo random correlation generator.

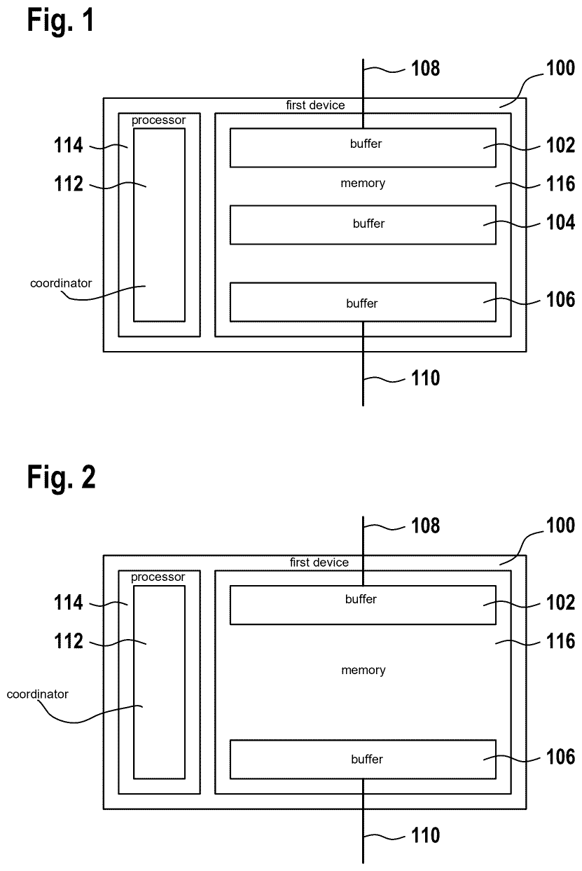

FIG. 2 schematically depicts an exemplary module for secure multi-party computation with correlated randomness based on a correlation generator.

The module for secure multi-party computation with correlated randomness based on a correlation generator comprises the buffer 102 for the first correlated randomness, the buffer 106 for the second correlated randomness, the input wire 108, the output wire 110, and the coordinator 112.

In contrast to the module for secure multi-party computation with correlated randomness based the pseudo random correlation generator, the module for secure multi-party computation with correlated randomness based on the correlation generator lacks the buffer 104 for the pseudo random correlation generator seed. In contrast to the module for secure multi-party computation with correlated randomness based on the pseudo random correlation generator, the module for secure multi-party computation with correlated randomness based on the correlation generator the second correlated randomness is determined from the first correlated randomness without the pseudo random correlation generator seed.

In contrast to the module for secure multi-party computation with correlated randomness based the pseudo random correlation generator, the coordinator 112 of the module for secure multi-party computation with correlated randomness based on the correlation generator is configured to schedule the determining of the second correlated randomness from the first correlated randomness without the pseudo random correlation generator seed.

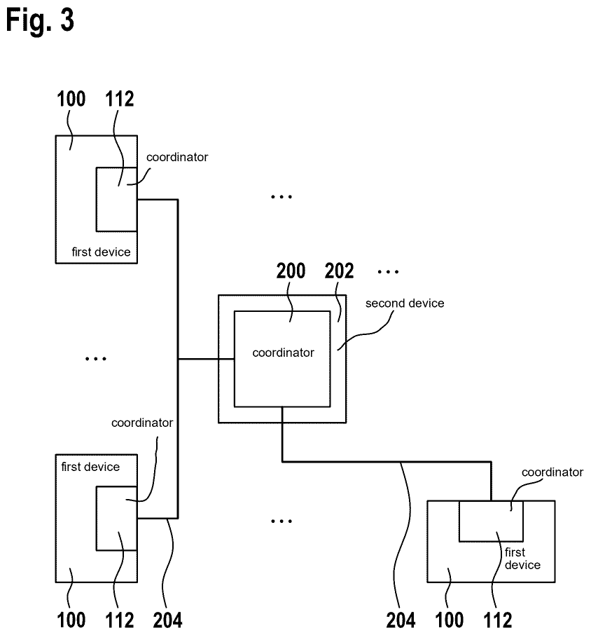

FIG. 3 schematically depicts an exemplary coordinator 200 for a plurality of modules for secure multi-party computation. The coordinator 200 for the plurality of modules and the respective coordinator 112 of the respective module are configured to communicate.

In the example, a second device 202 comprises the coordinator 200. According to an example, the second device 202 is a server in a internet infrastructure. The first device 100 and the second device 202 are configured to communicate via a respective communication link 204. At the respective first device 100, the respective communication link 204 provides the first correlated randomness to the input wire and receives the second correlated randomness from the output wire of the respective first device 100 to a corresponding output wire and input wire of the second device 200.

In the example, the coordinator 200 for the plurality of modules and the respective coordinator 112 of the respective module are configured to communicate via the respective communication link.

By way of example, the respective first device 100 and the second device 202 are described in a set up for secure multi-party computation with correlated randomness based on the pseudo random correlation generator. The set up for secure multi-party computation may comprise a first device 100 or first devices 100 that are configured for secure multi-party computation with correlated randomness based on the correlation generator.

The pseudo random correlation generator comprises an interactive generation protocol that generates private pseudo random correlation generator seeds from the first correlated randomness, and an expansion algorithm that is used to locally expand a respective pseudo random correlation generator seed into the second correlated randomness, i.e. secret shares of the correlated randomness.

In this context, in a two-party case, a correlated randomness is a sample (R₀, R₁) of a random variable, where a party P_{σ} of the secure multi-party computation holds a sample R_{σ} of the correlated randomness. Correlation in this context refers to the fact, that R₀, R₁ are not independent. An example for correlation is a Beaver triple, where the parties of the secure multi-party computation share a product (a₀+a₁)(b₀+b₁)=c₀+c₁ where the party P_{σ} knows the parts a_{σ}, b_{σ}, c_{σ} but not the other parts. The more party case is a generalization.

Correlation generation in this context refers to the task, to sample (R₀, R₁). In application, without a trusted party, this is realized with a secure protocol and/or with secure hardware, like a trusted execution environment.

Correlated randomness is generated for example in a secure multi-party computation offline phase. Correlated randomness is for example used in a secure multi-party computation online phase.

The phases may use large vectors of correlated randomness. E.g. a vector of millions of independent Beaver triples to support millions of secure multiplication in a secure multi-party computation online phase.

A pseudo random correlation generator is a correlation generator that according to an example comprises two algorithms: Gen and Expand. In the two-party case, the algorithm Gen outputs two short seed values s₀, s₁:

$$( {s}_{0} , {s}_{1} ) ← Gen$$

More generally, the algorithm Gen generates a respective pseudo random correlation generator seed for the parties of the secure multi-party computation. The algorithm Expand computes a correlated randomness for one party given its seed:

$${R}_{σ} ← Expand ( {s}_{σ} , σ )$$

A pseudo random correlation generator must satisfy security, i.e. privacy and correctness.

Correctness in this context refers to the values that the algorithm Expand outputs. The values must be distributed as specified by the correlated randomness that the pseudorandomcorrelation generator is supposed to generate.

Security in this context may refer to a set-up in which a first party cannot learn more information about a second party's part only from knowing the first party's part of the correlation and the first party's pseudo random correlation generator seed.

The correlation may be large, e.g. millions of triples to guarantee the security.

In applications, without a trusted party, the algorithm Gen, i.e., the generation of the respective seed, has to be realized by a secure protocol (generation protocol) and/or a trusted execution environment. Since the seeds are small, this can be realized in the secure protocol with low communication costs. A respective party can locally expand the seed s_{σ} of the respective party into the respective party's part R_{σ} of the correlated randomness.

The size of the respective seed may be less than a gigabyte, e.g., less than 10 megabyte, or less than 100 megabyte.

The correlated randomness may be more than a gigabyte.

In this context, scheduling may refer to executing the interactive and/or computational parts of the realization of Gen and/or the computational parts of the algorithm Expand based on available hardware, and/or time restriction.

The pseudo random correlation generator may be self-recursive. A self-recursive pseudo random correlation generator consumes a small amount of the first correlated randomness.

According to one example, the generation protocol may access the buffer 102 for the first correlated randomness. This means, the coordinator 112 comprises a part of the generation protocol that accesses the buffer 102 for the first correlated randomness and requests the correlated randomness, in particular the consumed amount of the correlated randomness from the buffer 106 for the second correlated randomness.

According to one example, the self-recursion is modelled depending on requests that the module sends. This means, the coordinator 112 comprises a model for modelling the self-recursion, in particular the consumed amount of the first correlated randomness, and is configured to request the correlated randomness, in particular the consumed amount of the first correlated randomness from the buffer 106 for the second correlated randomness.

The coordinator 200 for the plurality of modules for secure multi-party computation may be configured to receive requests from the pseudo random correlation generators participating in the secure multi-party computation and then distributes the correlated randomness among the pseudo random correlation generators.

The coordinator 200 for the plurality of modules for secure multi-party computation is configured for receiving a request for the first correlated randomness.

The coordinator 200 for the plurality of modules for secure multi-party computation is configured to send the first correlated randomness.

The coordinator 200 for the plurality of modules for secure multi-party computation may be configured to receive a request of a predetermined amount of the first correlated randomness and send the predetermined amount of the first correlated randomness.

The coordinator 200 for the plurality of modules for secure multi-party computation may be configured to send the first correlated randomness at a predetermined time.

In the example, the second device 202 is configured for receiving a request for the first correlated randomness.

In the example, the second device 202 is configured to send the first correlated randomness.

In the example, the second device 202 may be configured to receive a request of a predetermined amount of the first correlated randomness and send the predetermined amount of the first correlated randomness.

In the example, the second device 202 may be configured to send the first correlated randomness at a predetermined time.

The coordinator 200 for the plurality of modules for secure multi-party computation is configured for receiving a request for generating a pseudo random correlation generator seed from the first correlated randomness.

The coordinator 200 for the plurality of modules for secure multi-party computation is configured for sending the pseudo random correlation generator seed, in particular to the first device 100 of the requesting coordinator 112.

In the example, the second device 202 is configured for receiving the request for generating a pseudo random correlation generator seed from the first correlated randomness.

In the example, the second device 202 is configured for generating the pseudo random correlation generator seed from the first correlated randomness.

In the example, the second device 202 is configured for sending the pseudo random correlation generator seed, in particular to the first device 100 of the requesting coordinator 112.

In an exemplary topology of the communication that connects the pseudo random correlation generator modules, a communication of the pseudo random correlation generator modules is centrally organized by the coordinator 200 for the plurality of modules for secure multi-party computation.

In an exemplary topology of the communication that connects the pseudo random correlation generator modules, the pseudo random correlation generator modules communicate directly with each other, i.e. without the coordinator 200 for the plurality of modules for secure multi-party computation. This means, all pseudo random correlation generator modules are directly connected to the secure multi-party computation online phase. This means, the second device 202 is not required.

The coordination with the secure multi-party computation online phase may be centralized, while the pseudo random correlation generator modules exchange correlated randomness directly with each other.

Furthermore, pseudo random correlation generator modules for the same type of correlated randomness might use a common buffer.

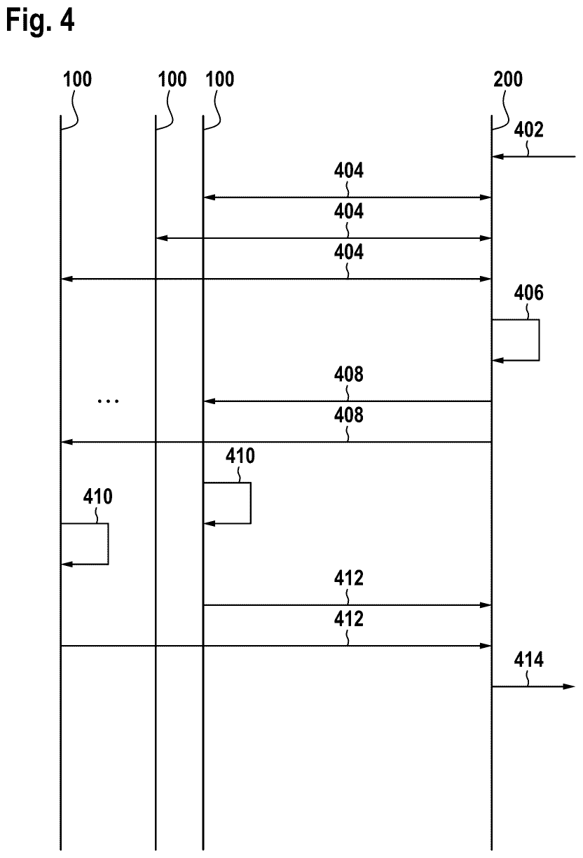

FIG. 4 depicts a sequence diagram of an exemplary method for coordinating the plurality of modules for secure multi-party computation with the coordinator 200 for the plurality of modules for secure multi-party computation. The modules in the example correspond to a respective first device 100.

According to the example for secure multi-party computation, an order O in the example comprises of three information O=(M, A, T), where M denotes a material type, A denotes an amount of the material, and T denotes a time at which the material M is supposed to be delivered.

The method comprises a step 402.

In step 402, the coordinator 200 for the plurality of modules for secure multi-party computation receives an order O=(M, A, T). The coordinator 200 for the plurality of modules for secure multi-party computation receives the order O for example from a secure multi-party computation online phase or from a coordinator 112.

The method comprises a step 404.

In step 404 the coordinator 200 for the plurality of modules for secure multi-party computation communicates with the plurality of modules for secure multi-party computation that produce material type M, to learn how much material each of the plurality of modules for secure multi-party computation can provide at time T, and if yes to which costs. According to the example, the coordinator 200 for the plurality of modules for secure multi-party computation communicates with the respective first device 100. According to an example, the respective device 100, in particular the respective coordinator 112 of the respective device 100 is configured to report how much material each of the plurality of modules for secure multi-party computation can provide at time T, and if yes to which costs.

According to an example, the coordinator 200 for the plurality of modules for secure multi-party computation and the respective coordinator 112 of the respective first device 100 send an order to make sure, that the respective buffer 102 for the first correlated randomness is sufficiently filled during the execution of the pseudo random correlation generator seed generation.

According to an example, the coordinators 112 of the modules are configured for sending an order to receive first correlated randomness to coordinate the amount of correlated randomness that is in a respective buffer 102 for the first correlated randomness.

The method comprises a step 406.

In step 406 the coordinator 200 for the plurality of modules for secure multi-party computation decides to which modules for secure multi-party computation are going to fulfill the order O. If necessary, a new module for secure multi-party computation is set up. The coordinator 200 for the plurality of modules for secure multi-party computation determines orders O_{P} such that the combination of all orders O_{P} fulfills O. The coordinator 200 for the plurality of modules for secure multi-party computation assigns the respective orders O_{P} to suitable modules for secure multi-party computation P,

The method comprises a step 408.

In step 408, the coordinator 200 for the plurality of modules for secure multi-party computation sends orders O_{P} to the respective suitable modules for secure multi-party computation.

According to the example, the orders O_{P} are sent to suitable first devices 100. the respective order O_{P} comprises the material type M, and the time T given in the Order O. According to the example, the respective order O_{P} comprises a respective amount A_{P} that is selected, e.g., by the coordinator 200, e.g. depending on the total of the available secure multi-party computation modules, in such a way, that the total amount A is provided by the orders O_{P}.

The respective modules for secure multi-party computation receive the respective order O_{P}. According to an example, the respective device 100 receives the respective order O_{P}.

The method comprises a step 410.

In step 410, the respective coordinator 112 of the respective first device 100 schedules the secure multi-party computation.

In case the respective first device 100 uses the seed generation protocol and expansion algorithm the respective coordinator 112 schedules the determining of the second correlated randomness depending on the first correlated randomness, wherein the seed generation protocol is executed for generating the pseudo random correlation generator seed depending on the first correlated randomness, and wherein the expansion algorithm is executed for determining the second correlated randomness from the pseudo random correlation generator seed.

In case the respective first device 100 uses the correlation generator without the pseudo random correlation generator seed, the respective coordinator 112 schedules the determining of the second correlated randomness depending on the first correlated randomness.

In this context, the O_{P} corresponds to the first correlated randomness and a respective amount A_{P} of material M_{P} of material type M corresponds to the second correlated randomness.

The method comprises a step 412.

In step 412, the respective coordinator 112 of the respective first device 100 sends the respective amount A_{P} of material M_{P} of material type M. In the example, the respective coordinator 112 of the respective first device 100 sends the respective amount A_{P} of material M_{P} of material type M at a time T.

According to the example, the respective coordinator 112 of the respective first device 100 sends the respective material M_{P} to the coordinator 200 for the plurality of modules for secure multi-party computation.

According to an example, the respective coordinator 112 of the respective device 100 schedules the pseudo random correlation generator seed protocol to fill the buffer 104 for the pseudo random correlation generator seed.

According to an example, the respective coordinator 112 of the respective device 100 schedules the expansion algorithm to fill the buffer 106 for the second correlated randomness.

The method comprises a step 414.

In step 414, the coordinator 200 for the plurality of modules for secure multi-party computation forwards the respective material M_{P} to a recipient, e.g., the multi-party computation offline phase or a coordinator 112.

The coordinator 200 for the plurality of modules for secure multi-party computation may be configured for processing several orders simultaneously or overlapping timewise. The method may be executed for the plurality of modules for secure multi-party computations in parallel or overlapping timewise.

The coordinator 200 for the plurality of modules for secure multi-party computation may be configured for setting up and/or shutting down pseudo random correlation generator modules and/or correlation generator modules.

The coordinator 200 for the plurality of modules for secure multi-party computation may be configured for cancelling an order entirely or cancelling a respective order O_{P} for respective material M_{P}.

The coordinator 200 for the plurality of modules for secure multi-party computation may be configured for reordering the same material M_{P} that is cancelled from another pseudo random correlation generator module and/or correlation generator module.

The coordinator 200 for the plurality of modules for secure multi-party computation may be configured for selecting a respective pseudo random correlation generator module and/or correlation generator module for placing a respective order O_{P} based on the cost that is associated with placing the respective order O_{P} at the respective module. The coordinator 200 for the plurality of modules for secure multi-party computation may be configured for selecting a cheaper module or cheaper modules before other modules.

The method may comprise selecting the respective pseudo random correlation generator module and/or correlation generator module for placing a respective order O_{P} based on the cost that is associated with placing the respective order O_{P} at the respective module. The method may comprise selecting a cheaper module or cheaper modules before other modules.

The coordinator 200 for the plurality of modules for secure multi-party computation may be configured for reacting to a behavior of a respective pseudo random correlation generator module and/or correlation generator module. The coordinator 200 for the plurality of modules for secure multi-party computation may be configured for cancelling or not placing a respective order O_{P} based on the behavior of the respective pseudo random correlation generator module and/or correlation generator module.

The method may comprise reacting to a behavior of a respective pseudo random correlation generator module and/or correlation generator module. The method may comprise cancelling or not placing a respective order O_{P} based on the behavior of the respective pseudo random correlation generator module and/or correlation generator module.

The behavior may be related to security features provided by the respective pseudo random correlation generator module and/or correlation generator module.

The behavior may be related to timeliness or precision of the respective material M_{P} provided by the respective pseudo random correlation generator module and/or correlation generator module.

For example, the coordinator 200 for the plurality of modules for secure multi-party computation is configured for detecting an insecure, an untimely, and/or an unprecise delivery of material M_{P}. For example, the coordinator 200 for the plurality of modules for secure multi-party computation is configured for stopping to use a respective pseudo random correlation generator module and/or correlation generator module in case an insecure, an untimely, and/or an unprecise delivery of material M_{P} is detected.

For example, the method comprises detecting an insecure, an untimely, and/or an unprecise delivery of material M_{P}. For example, the method comprises stopping to use a respective pseudo random correlation generator module and/or correlation generator module in case an insecure, an untimely, and/or an unprecise delivery of material M_{P} is detected.

A decentralized system may be provided, that operates without the coordinator 200 for the plurality of modules for secure multi-party computation. In the decentralized system, the coordinators 112 of the plurality of modules for secure multi-party computation may be configured for interacting with each other to provide the functionality described for the coordinator 200 for the plurality of modules for secure multi-party computation.

The method in the decentralized system comprises an interaction between the respective pseudo random correlation generator modules and/or correlation generator modules directly.

In a case, wherein several modules share a common buffer 102 for the first correlated randomness, the method may comprise using the common buffer 102.

By way of an example, the method is described for a pseudo random correlation generator for Beaver triples from Beaver triples. The method applies to other pseudo random correlation generators as well.

The first correlated randomness of the pseudo random correlation generator according to the example has the type of Beaver triples. This means, the pseudo random correlation generator according to the example is a Learning Parity with Noise based, i.e., LPN-based, pseudo random correlation generator with preprocessing that only requires Beaver triples. The pseudo random correlation generator according to the example uses a collection of distributed point functions, DPF.

In the example to generate Beaver triples over a field [symbol] , the first correlated randomness consists of Beaver triples over [symbol] and an internal binary field [symbol] .

In the example to generate Beaver triples over [symbol] , the coordinator 112 request Beaver triples over [symbol] to fill the buffer 102 from the buffer 106 for the second correlated randomness (self-recursion).

In the example to generate Beaver triples over [symbol] , the coordinator 112 sends a request for Beaver triples over [symbol] to fill the buffer 102 for the first correlated randomness.

For the generation of Beaver triples over [symbol] , an device 100 is used, that determines Beaver triples over [symbol] as second correlated randomness. The coordinator 112 may send request to the buffer 106 for the second correlated randomness to fill the buffer 102 for the first correlated randomness (self-recursion).

The correlations over the binary field [symbol] are used for multi-party computation with bitwise operations inside protocols realizing the seed generation of the pseudorandom correlation generator for Beaver triples over [symbol] and/or [symbol] .

A ring R for the ring-LPN assumptions is of the form R= [symbol] [X]/F, where the polynomial modulus F has a degree N=2ⁿ. According to an example, n is between 15 and 25, in particular 19, 20, or 21.

The ring-LPN assumption is applied to generate correlated randomness over [symbol] ^{N}, i.e., to the case of N-many independent random instances of correlated randomness over [symbol] . For example, the N-many independent random instances are represented by N-many Beaver triples.

The polynomial modulus F fulfills two requirements:

The polynomial F is fully reducible with N many different roots over [symbol] .

There exists an efficient modular multiplication in R.

In the example of the pseudorandom correlation generator for Beaver triples over [symbol] the ring R is

$$R = {𝔽}_{{2}^{λ}} [ X ] / ( {X}^{M} + 1 ) ≅ {𝔽}_{{2}^{λ}}^{M}$$

where M is a divisor of 2^{λ}−1, and where M≈N.

Over this ring R, efficient polynomial multiplication is possible with the Number Theoretic Transform and with respect to a M-th root of unity over [symbol] .

Fast algorithms for the NTT can be constructed with Fast Fourier Transformation algorithms, for example the multidimensional Fast Fourier Transform, to reduce the degree M into smaller degrees, depending on the factorization of M Afterwards, other efficient small degree-NTT algorithms can be used.

The DPF are for example constructed in such a way, that the internal use of secure multi party computation only consumes Beaver triples as correlated randomness.

In the example to generate Beaver triples from Beaver triples, the methods of the pseudorandom correlation generator comprises instances that are correlated, encoding the correlation of the correlated randomness.

The example to generate Beaver triples form Beaver triples is a special case to generate correlated randomness, for other correlated randomness. An example for correlated randomness are Beaver triples, square tuples, random shared values and tuples for polynomial and matrix operations.

What is claimed is:

1. A first device for secure multi-party computation, the first device being configured to receive first correlated randomness, and to determine second correlated randomness depending on the first correlated randomness, the first device including a coordinator that is configured to: (i) schedule the determining of the second correlated randomness, and/or (ii) request a predetermined amount of the first correlated randomness at a predetermined time, from a coordinator for multiple devices for secure multi-party computation, and/or (iii) send a predetermined amount of the second correlated randomness at a predetermined time.

2. The first device according to claim 1, wherein the coordinator is configured to: (i) receive a request for sending the predetermined amount of the second correlated randomness at the predetermined time, from the coordinator for multiple devices for secure multi-party computation, and (ii) send the predetermined amount of the second correlated randomness upon receipt of the request at the predetermined time.

3. The first device according to claim 1, wherein the device comprising:
a buffer for the first correlated randomness, wherein the coordinator is configured to read an amount of the first correlated randomness that is stored in the buffer for the first correlated randomness, and to request the predetermined amount of the first correlated randomness, when the amount of the correlated randomness is less than a predetermined threshold, and/or
a buffer for the second correlated randomness, wherein the coordinator is configured to read an amount of the second correlated randomness that is stored in the buffer for the second correlated randomness, and to send the predetermined amount of the second correlated randomness.

4. The first device according to claim 1, wherein the first device is configured to generate a pseudo random correlation generator seed depending on the first correlated randomness, and determine the second correlated randomness depending on the pseudo random correlation generator seed, and wherein the coordinator is configured to schedule the generation of the pseudo random correlation generator seed from the first correlated randomness.

5. The first device according to claim 4, wherein the first device comprises:
a buffer for pseudo random correlation generator seeds, wherein the coordinator is configured to read an amount of pseudo random correlation generator seeds that is stored in the buffer for the pseudo random correlation generator seeds, and to request the generation of the pseudo random correlation generator seed from the first correlated randomness, when the amount of pseudo random correlation generator seeds is less than a predetermined threshold.

6. The first device according to claim 1, wherein the first device comprising:
an input wire configured for reading in the first correlated randomness.

7. The first device according to claim 1, wherein the first device comprises:
an output wire configured for sending the second correlated randomness.

8. A second device for secure multi-party computation, the second device being configured to receive a request for a predetermined amount of first correlated randomness at a predetermined time, and send the predetermined amount of first correlated randomness at the predetermined time.

9. A first method for secure multi-party computation in a first device for secure multi-party computation, the first method comprising:
receiving first correlated randomness;
determining second correlated randomness depending on the first correlated randomness;
using a coordinator in the first device: (i) scheduling the determining of the second correlated randomness, and/or (ii) requesting a predetermined amount of the first correlated randomness at a predetermined time from a coordinator for multiple devices for secure multi-party computation, or a buffer for the second correlated randomness, and/or (iii) sending a predetermined amount of the second correlated randomness at a predetermined time to the buffer for the second correlated randomness.

10. The first method according to claim 9, further comprising:
receiving, using the coordinator of the first device, a request: (i) for sending the predetermined amount of the second correlated randomness at the predetermined time, from the coordinator for multiple devices for secure multi-party computation, or the buffer for the second correlated randomness, and (ii) for sending the predetermined amount of the second correlated randomness upon receipt of the request at the predetermined time.

11. The first method according to claim 9, wherein:
the first device includes a buffer: (i) for the first correlated randomness, wherein the first method further comprises reading, using the coordinator of the first device, an amount of the first correlated randomness that is stored in the buffer for the first correlated randomness, and (ii) for requesting the predetermined amount of the first correlated randomness, when the amount of the correlated randomness is less than a predetermined threshold, and/or
the first device includes a buffer: (i) for the second correlated randomness, wherein the first method further comprises reading, using the coordinator of the first device, an amount of the second correlated randomness that is stored in the buffer for the second correlated randomness, and (ii) for sending the predetermined amount of the second correlated randomness.

12. The first method according to claim 9, wherein the first method further comprises generating a pseudo random correlation generator seed depending on the first correlated randomness, and determining the second correlated randomness depending on the pseudo random correlation generator seed, and scheduling, using the coordinator of the first device, the generation of the pseudo random correlation generator seed from the first correlated randomness.

13. The first method according to claim 12, wherein the first device includes a buffer for pseudo random correlation generator seeds, wherein the first method further comprises reading, using the coordinator of the first device, an amount of pseudo random correlation generator seeds that is stored in the buffer for the pseudo random correlation generator seeds, and requesting, using the coordinator of the first device, the generation of the pseudo random correlation generator seed from the first correlated randomness, when the amount of pseudo random correlation generator seeds is less than a predetermined threshold.

14. A second method for secure multi-party computation, the second method comprising:
receiving a request for a predetermined amount of, first correlated randomness at a predetermined time; and
sending the predetermined amount of first correlated randomness at the predetermined time.

15. A non-transitory computer-readable storage medium on which is stored a computer program including computer-readable instructions for secure multi-party computation in a first device for secure multi-party computation, the computer program, when executed by a computer, causing the computer to perform the following steps:
receiving first correlated randomness;
determining second correlated randomness depending on the first correlated randomness;
using a coordinator in the first device: (i) scheduling the determining of the second correlated randomness, and/or (ii) requesting a predetermined amount of the first correlated randomness at a predetermined time from a coordinator for multiple devices for secure multi-party computation, or a buffer for the second correlated randomness, and/or (iii) sending a predetermined amount of the second correlated randomness at a predetermined time to the buffer for the second correlated randomness.
